(19) United States
(12) Patent Application Publication
(10) Pub. No.: US 2009/0172716 A1
(43) Pub. Date: Jul. 2, 2009

(54) Disk Device

(75) Inventors: Koichi Tokumoto, Saitama (JP); Hideo Ito, Saitama (JP); Toshiyuki Tanaka, Saitama (JP)

Correspondence Address: FOLEY AND LARDNER LLP;SUITE 500, 3000 K STREET NW, WASHINGTON, DC, 20007, US

(73) Assignee: Pioneer Corporation

(21) Appl. No.: 12/085,025

(22) PCT Filed: Nov. 14, 2006
(86) PCT No.: PCT/JP2006/322647

§ 371 Date: Aug. 18, 2008

(30) Foreign Application Priority Data
Nov. 18, 2005 (JP) 2005-334772

(51) Int. Cl. G11B 17/03

(52) U.S. Cl. 720/601; G9B/17.009

(57) ABSTRACT

A relative-moving-side projection is formed on a front surface and a fixed-side groove that can engage with a fixed-side projection is formed on a rear surface of a tray. The fixed-side projection is formed on a bottom surface of a chassis. A relative-moving-side groove that can engage with the relative-moving-side projection is formed on a ceiling surface of an upper case. When the tray is moved from a disk loading position to a disk reproducing position, a state where the relative-moving-side projection and the fixed-side projection respectively engage with the relative-moving-side groove and the fixed-side groove is maintained. The relative-moving-side projection moves with respect to the fixed-side projection while the tray is moved.

### TECHNICAL FIELD

The present invention relates to a disk device, and more particularly, to a disk device including a tray that carries a disk in and out of the disk device.

### BACKGROUND ART

In some disk devices, when a disk is loaded on a tray located at a disk loading position that is outside of the disk device, the tray on which the disk is loaded is moved from the disk loading position to a disk reproducing position that is inside the disk device thereby carrying the disk in the disk device. In the disk device that employs a tray to carry a disk, when the tray is moved from the disk loading position to the disk reproducing position, it is necessary to restrain the tray from being tilted to a width direction of the disk device or being run off. Therefore, in conventional disk devices, a projection-groove structure is employed in the tray and the disk device, i.e., a projection formed on one part and a groove formed on other part are made to engage with each other.

For example, a disk device disclosed in Patent Document 1 includes grooves, a plurality of first guide pieces, and guide projections. One groove is formed on each side surface of a tray to extend in a moving direction of the tray. The first guide pieces and the guide projections are formed in the disk device, particularly, on a frame of the disk device opposed to the tray at positions opposed to each of the grooves. In the disk device disclosed in Patent Document 1, when the tray is located at a disk loading position, each of the guide projections engages with a corresponding one of the grooves. As the tray is moved from the disk loading position to a disk reproducing position, the first guide pieces sequentially engage with the opposed groove.

Patent Document 1: Japanese Patent Application Laid-open No. 2003-296995

### DISCLOSURE OF INVENTION

### Problem to be Solved by the Invention

Among the disk devices that employ a tray to carry a disk, some of the disk devices can handle a naked disk and a disk that is housed in a cartridge (hereinafter, either disk is referred to just “a disk”). Handle a disk here means performing at least any one of reproduction of information recorded on a disk and recording of information on the disk. In a cartridge compatible disk device, which is a disk device that even can handle a disk that is housed in a cartridge, when a cartridge is loaded on a tray located at a disk loading position that is outside of the disk device, the tray is moved from the disk loading position to a disk reproducing position that is inside the disk device thereby carrying the cartridge in the disk device.

In the cartridge compatible disk device, when the tray on which the cartridge is loaded is moved to the disk reproducing position, a shutter of the cartridge needs to be opened by a sliding member that is slidably supported by the tray so that a disk housed in the cartridge is exposed to the outside. However, a bias force in a direction of closing the shutter is exerted on the shutter by using a spring. In other words, the sliding member opens the shutter against the bias force.

The sliding member slides, for example, by the action of a cam mechanism arranged between the sliding member and an inner wall surface of the disk device opposed to the sliding member in conjunction with a movement of the tray. Therefore, when the shutter is opened by a sliding movement of the sliding member, the tray being moved may be tilted due to the bias force acting on the shutter. Consequently, in the conventional disk device, it becomes hard for the plurality of the first guide pieces to sequentially engage with the opposed groove. As a result, an impact generated when each of the first guide pieces engages with the opposed groove is transmitted to the tray and can cause swaying of the tray. In addition, if the tray being moved is tilted, the plurality of the first guide pieces may collide with components arranged therearound till all the plurality of the first guide pieces engage with the opposed grooves, and thereby swaying the tray being moved.

Furthermore, the conventional disk device needs to include a plurality of projections to be engaged with each of the grooves, such as the guide pieces and the guide projections. Therefore, it is necessary to form a space for the plurality of the projections in the disk device, so that the disk device cannot be downsized.

The present invention has been developed to solve the above problems as an example. An object of the present invention is to provide a disk device capable of realizing at least any one of a restraint of a tray being moved so that it does not sway and downsizing of the disk device.

### Means for Solving Problem

A disk device according to claim 1 of the present invention is a disk device that performs at least any one of reproduction of information recorded on a disk and recording of information on the disk and includes a relative-moving-side projection formed on a tray being moved between a disk loading position at which the disk is loaded and a disk reproducing position at which information in a loaded disk is reproduced or information is recorded on the loaded disk; a relative-moving-side groove formed at least in a moving area of the relative-moving-side projection with respect to the disk device such a manner that the relative-moving-side projection engages with the relative-moving-side groove in the disk device; a fixed-side projection formed on a position in the disk device to be opposed to the tray; and a fixed-side groove formed at least in a moving area of the tray with respect to the fixed-side projection such a manner that the fixed-side projection engages with the fixed-side groove on the tray.

A disk device according to claim 4 of the present invention is a disk device that performs at least any one of reproduction of information recorded on a disk and recording of information on the disk and includes a pair of relative-moving-side guide projections formed on a tray being moved between a disk loading position at which the disk is loaded and a disk reproducing position at which information in a loaded disk is reproduced or information is recorded on the loaded disk; a relative-moving-side rib formed at least in a moving area of the pair of the relative-moving-side guide projections with respect to the disk device such a manner that the relative-moving-side rib is sandwiched between the pair of the relative-moving-side guide projections in the disk device; a pair of fixed-side guide projections formed on a position to be opposed to the tray in the disk device; and a fixed-side rib formed at least in a moving area of the tray with respect to the pair of the fixed-side guide projections such a manner that the fixed-side rib is sandwiched between the pair of the fixed-side guide projections.

### EFFECT OF THE INVENTION

A disk device according to the present invention can realize at least any one of a restraint of a tray being moved so that it does not sway and downsizing of the disk device.

### BRIEF DESCRIPTION OF DRAWINGS

FIG. 1-1 is a cross sectional view of a main portion of a disk device according to a first practical example of the present invention.

FIG. 1-2 is an enlarged view of a portion A shown in FIG. 1-1.

FIG. 2-1 is a diagram (a plan view) illustrating a configuration example of a chassis.

FIG. 2-2 is a diagram (a front elevational view) illustrating the configuration example of the chassis.

FIG. 3-1 is a diagram (a plan view) illustrating a configuration example of a tray.

FIG. 3-2 is a cross-sectional view of the tray along a line B-B shown in FIG. 3-1.

FIG. 4-1 is a diagram (a rear view) illustrating a configuration example of an upper case.

FIG. 4-2 is a cross-sectional view of the upper case along a line C-C shown in FIG. 4-1.

FIG. 5 is a diagram illustrating a configuration example of the disk device at a disk loading position.

FIG. 6 is a diagram illustrating a configuration example of the disk device at a disk reproducing position.

FIG. 7-1 is a diagram (a plan view) illustrating another configuration example of the chassis.

FIG. 7-2 is a diagram (a front elevational view) illustrating the another configuration example of the chassis.

FIG. 7-3 is a cross sectional view of a relative-moving-side groove.

FIG. 8-1 is a diagram (a plan view) illustrating another configuration example of the tray.

FIG. 8-2 is a cross-sectional view of the tray along a line D-D shown in FIG. 8-1.

FIG. 9-1 is a cross sectional view of a main portion of a disk device according to a second practical example of the present invention.

FIG. 9-2 is an enlarged view of a portion E shown in FIG. 9-1.

FIG. 10-1 is a diagram (a plan view) illustrating a configuration example of a chassis.

FIG. 10-2 is a diagram (a front elevational view) illustrating the configuration example of the chassis.

FIG. 11-1 is a diagram (a plan view) illustrating a configuration example of a tray.

FIG. 11-2 is a cross-sectional view of the tray along a line F-F shown in FIG. 11-1.

FIG. 12-1 is a diagram (a rear view) illustrating a configuration example of an upper case.

FIG. 12-2 is a cross-sectional view of the upper case along a line G-G shown in FIG. 12-1.

### EXPLANATIONS OF LETTERS OR NUMERALS

1-1, 1-2 Disk device
2 Chassis
21 Mounting space
22a-22d Positioning pin
23a-23d Fixation hole
24 Bottom surface
25 Fixed-side projection
26 Relative-moving-side groove
27a, 27b Fixed-side guide projection
3 Tray
3a Rear surface
3b Front surface
31 Loading portion
31a, 31b Concave loading portion
31c Positioning pin
32 Fixed-side groove
33 Relative-moving-side projection
34 Sliding member
35 Relative-moving-side projection
36 Fixed-side rib
37a, 37b Relative-moving-side guide projection
4 Upper case
41 Ceiling surface
42a-42d Positioning hole 43a-43d Fixation hole
44 Relative-moving-side groove
45 Relative-moving-side rib

### BEST MODE(S) FOR CARRYING OUT THE INVENTION

Exemplary embodiments and practical examples of the present invention are explained in detail below with reference to the accompanying drawings; however, the present invention is not limited to these embodiments and practical examples. Components described in the following embodiments and practical examples include those can be easily conceived by a person skilled in the art or those substantially equivalent thereto. In the following practical examples, a disk device capable of reproducing information recorded on either a disk housed in a cartridge or a disk not housed in a cartridge or recording information on the either disk is explained, but the present invention is not limited to the disk device. For example, the present invention can be applied to a disk device capable of reproducing information recorded on only a disk not housed in a cartridge or recording information on the disk.

### First Embodiment

A disk device according to a first embodiment of the present invention performs at least any one of reproduction of information recorded on a disk and recording of information on the disk. The disk device includes a relative-moving-side projection, a relative-moving-side groove, a fixed-side projection, and a fixed-side groove. The relative-moving-side projection and the relative-moving-side groove, and the fixed-side projection and the fixed-side groove respectively compose a sliding mechanism composed of the projection and the groove. The relative-moving-side projection is formed on a tray being moved between a disk loading position at which the disk is loaded and a disk reproducing position at which information in the loaded disk is reproduced or information is recorded on the loaded disk. The relative-moving-side groove is formed at least in a moving area of the relative-moving-side projection with respect to the disk device such that the relative-moving-side projection can engages with the relative-moving-side groove in the disk device. The fixed-side projection is formed on a position in the disk device to be opposed to the tray. The fixed-side groove is formed at least in a moving area of the tray with respect to the fixed-side projection such that the fixed-side projection can engages with the fixed-side groove on the tray.

Because the disk device according to the first embodiment has the above configuration, the relative-moving-side projection moves in a moving direction of the tray with respect to the relative-moving-side groove in a state where the relative-moving-side projection is engaged with the relative-moving-side groove while the tray is being moved. Moreover, the fixed-side groove moves in the moving direction of the tray with respect to the fixed-side projection in a state where the fixed-side projection is engaged with the fixed-side groove while the tray is being moved. Namely, while the tray is moved from the disk loading position to the disk reproducing position, the relative-moving-side projection relatively moves away with respect to the fixed-side projection. Therefore, while the tray is being moved, the tray is constantly restrained from being moved in a width direction of the disk device at two points. As a result, while the tray is being moved, the projection never engages with the groove. Furthermore, the tray is restrained from being tilted while the tray is being moved, and thereby preventing the relative-moving-side projection and the fixed-side groove of the tray from colliding with components arranged in the disk device. Consequently, it is possible to suppress swaying of the tray when the tray is moved.

Moreover, in the disk device according to the first embodiment, the movement of the tray in the width direction of the disk device can be restrained by the two sliding mechanisms composed of the relative-moving-side projection and the relative-moving-side groove, and the fixed-side projection and the fixed-side groove, respectively. Therefore, it is not necessary to include a plurality of projections to be engaged with a groove as those employed in a conventional disk device, so that the disk device can be downsized.

### Second Embodiment

In a disk device according to a second embodiment of the present invention, in the disk device according to the first embodiment, the relative-moving-side projection and the fixed-side groove are respectively formed on an opposite surface of the tray. However, the fixed-side groove is formed on a position to be overlapped with the moving area of the relative-moving-side projection with respect to the disk device in a thickness direction of the disk device.

Because the disk device according to the second embodiment has the above configuration, the fixed-side projection is constantly located on the moving area of the relative-moving-side projection with respect to the disk device while the tray is moved from the disk loading position to the disk reproducing position. Therefore, the tray can be restrained from being tilted to the width direction of the disk device while the tray is moved from the disk loading position to the disk reproducing position as compared with a case where the relative-moving-side projection and the fixed-side projection are not arranged on the same straight line. Consequently, it is possible to more reliably suppress swaying of the tray when the tray is moved.

### Third Embodiment

In a disk device according to a third embodiment of the present invention, in the disk device according to the first embodiment or the second embodiment, when the tray is located at the disk loading position, the relative-moving-side projection is located on the side of the disk reproducing position as compared with the fixed-side projection.

Because the disk device according to the third embodiment has the above configuration, the relative-moving-side projection is not overlapped with the fixed-side projection in the thickness direction of the disk device while the tray is being moved. Therefore, the tray can be restrained from being tilted to the width direction of the disk device that is caused when the relative-moving-side projection is overlapped with the fixed-side projection in the thickness direction of the disk device while the tray is being moved. Consequently, it is possible to more reliably suppress swaying of the tray when the tray is moved.

### Fourth Embodiment

A disk device according to a fourth embodiment of the present invention performs at least any one of a reproduction of information recorded on a disk and a recording of information on the disk. The disk device includes a pair of relative-moving-side guide projections, a relative-moving-side rib, a pair of fixed-side guide projections, and a fixed-side rib. The pair of the relative-moving-side guide projections and the relative-moving-side rib, and the pair of the fixed-side guide projections and the fixed-side rib respectively compose a sliding mechanism composed of the pair of the guide projections and the rib. The pair of the relative-moving-side guide projections is formed on a tray being moved between a disk loading position at which the disk is loaded and a disk reproducing position at which information in the loaded disk is reproduced or information is recorded on the loaded disk. The relative-moving-side rib is formed at least in a moving area of the pair of the relative-moving-side guide projections with respect to the disk device such that the relative-moving-side rib is sandwiched between the pair of the relative-moving-side guide projections in the disk device. The fixed-side guide projections are formed on a position to be opposed to the tray in the disk device. The fixed-side rib is formed at least in a moving area of the tray to be opposed to the pair of the fixed-side guide projections in a state where the fixed-side rib is sandwiched between the pair of the fixed-side guide projections.

Because the disk device according to the fourth embodiment has the above configuration, the pair of the relative-moving-side guide projections moves in a moving direction of the tray with respect to the relative-moving-side rib in a state where the pair of the relative-moving-side guide projections sandwiches the relative-moving-side rib therebetween while the tray is being moved. Moreover, the fixed-side rib moves in the moving direction of the tray with respect to the pair of the fixed-side guide projections in a state where the pair of the fixed-side guide projections sandwiches the fixed-side rib therebetween while the tray is being moved. Namely, while the tray is moved from the disk loading position to the disk reproducing position, the pair of the relative-moving-side guide projections relatively moves away with respect to the pair of the fixed-side guide projections. Therefore, while the tray is being moved, the tray is constantly restrained from being moved in a width direction of the disk device at two points. As a result, while the tray is being moved, the rib that is not sandwiched between the guide projections is never sandwiched between the guide projections. Furthermore, the tray is restrained from being tilted while the tray is being moved, and thereby preventing the relative-moving-side rib and the fixed-side rib from colliding with components arranged in the disk device. Consequently, it is possible to suppress swaying of the tray when the tray is moved.

Moreover, in the disk device according to the fourth embodiment, the movement of the tray in the width direction of the disk device can be restrained by the two sliding mechanisms composed of the pair of the relative-moving-side guide projections and the relative-moving-side rib, and the pair of the fixed-side guide projections and the fixed-side rib, respectively. Therefore, it is not necessary to include a plurality of pairs of the guide projections for sandwiching the rib therebetween as those employed in a conventional disk device, so that the disk device can be downsized.

### First practical example

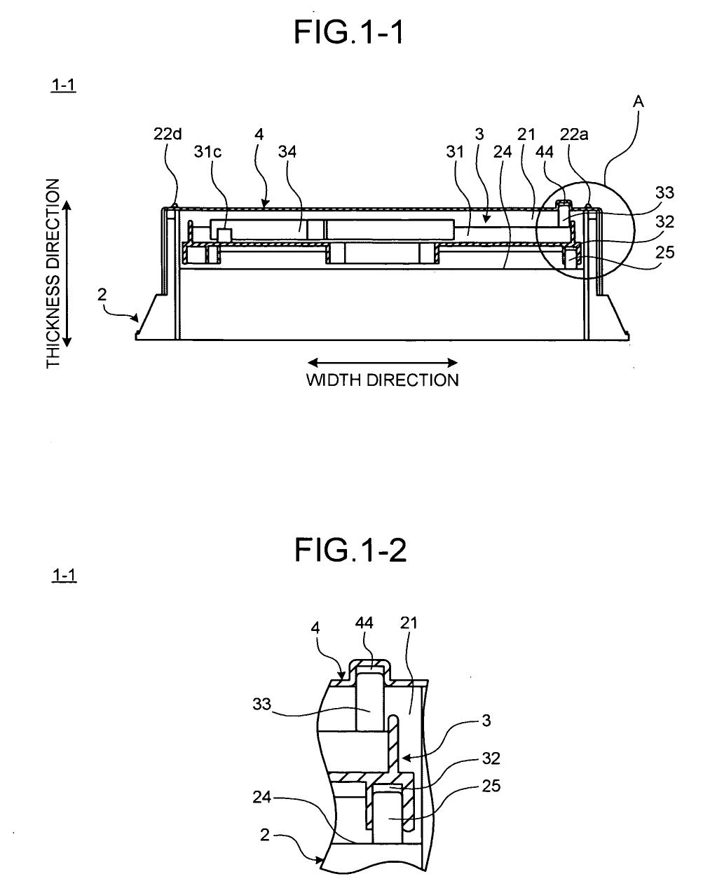

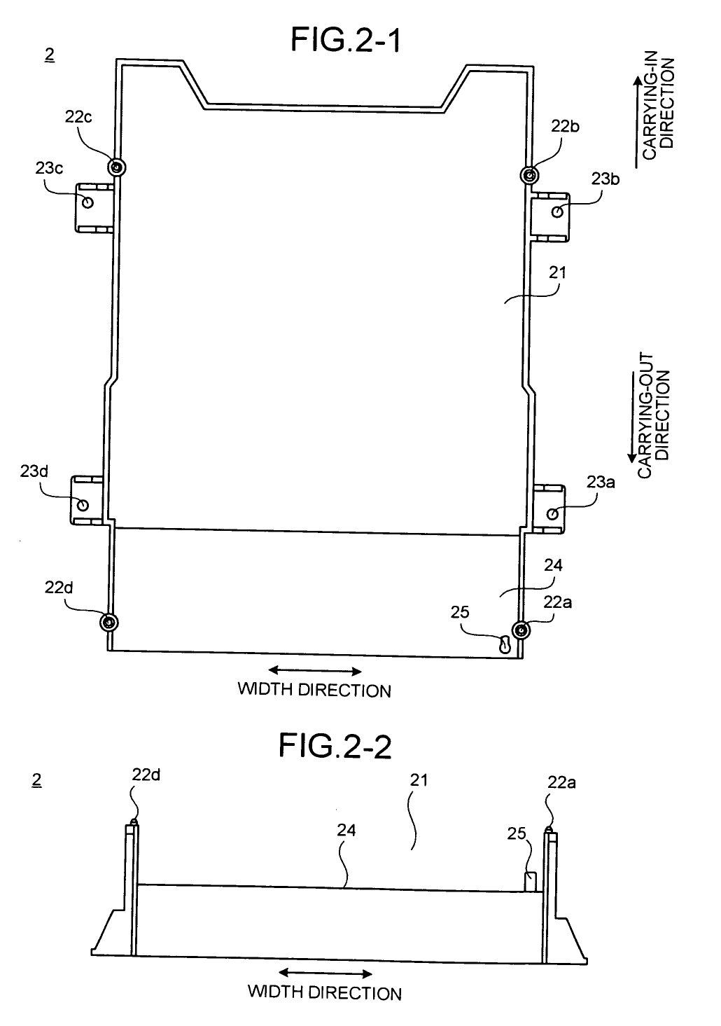

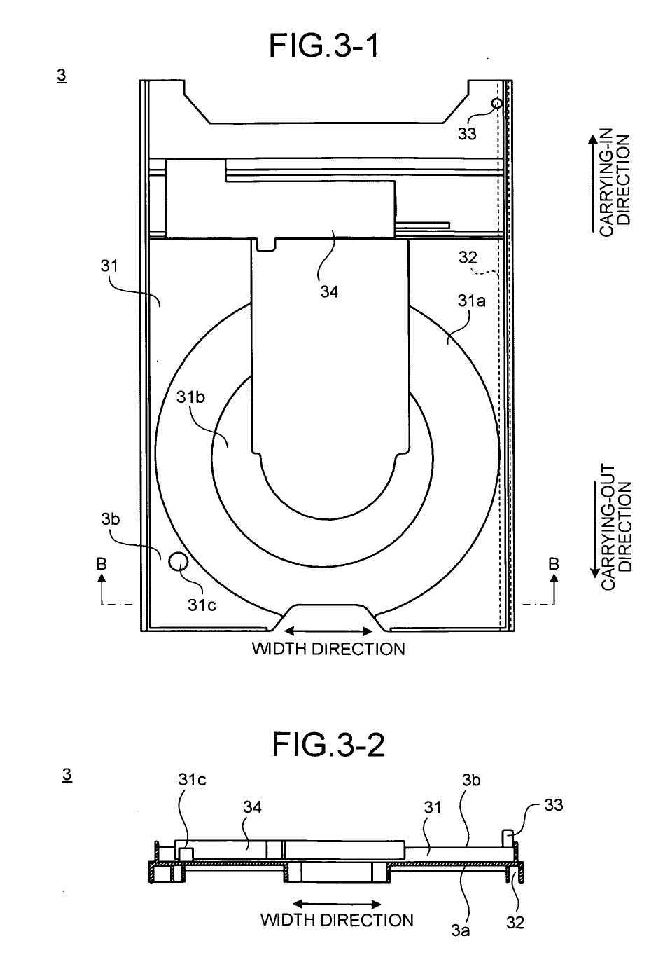

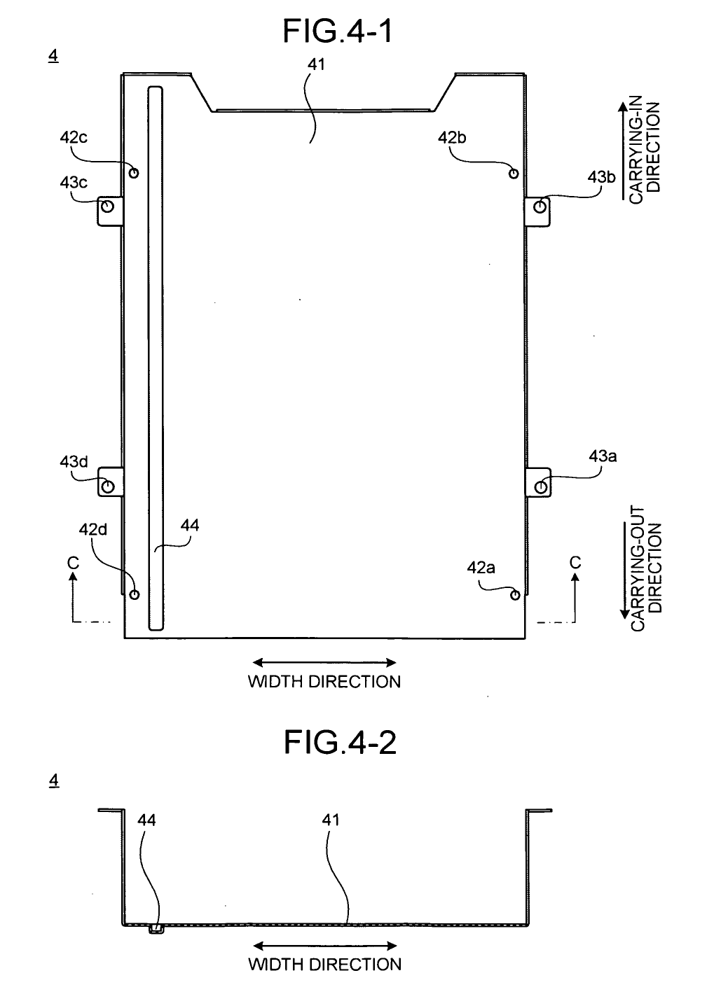

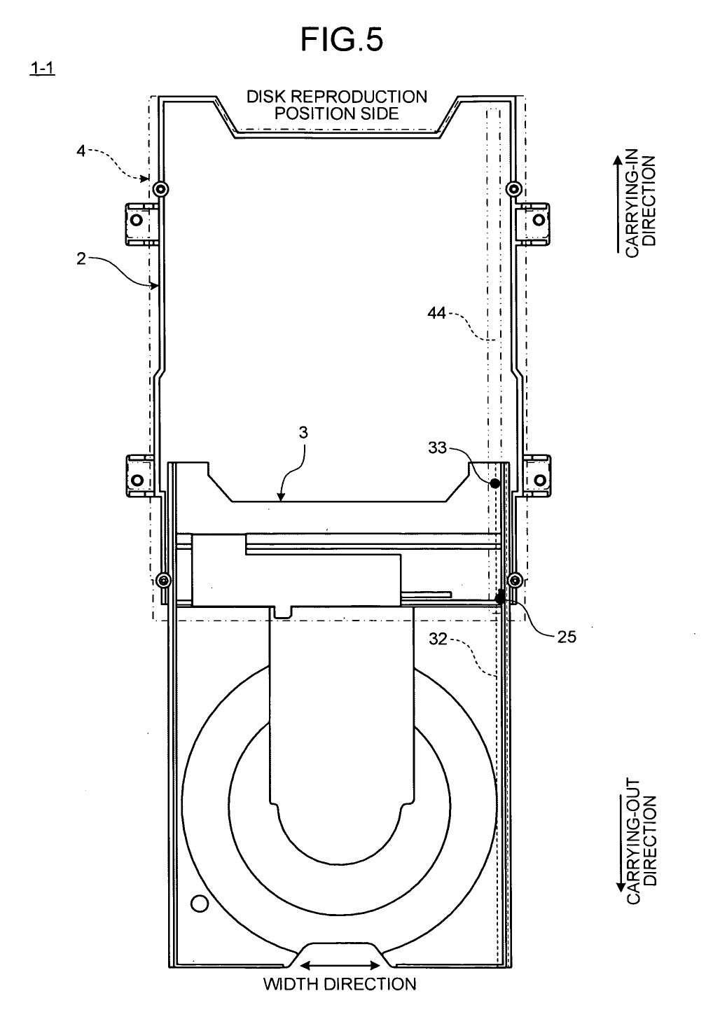

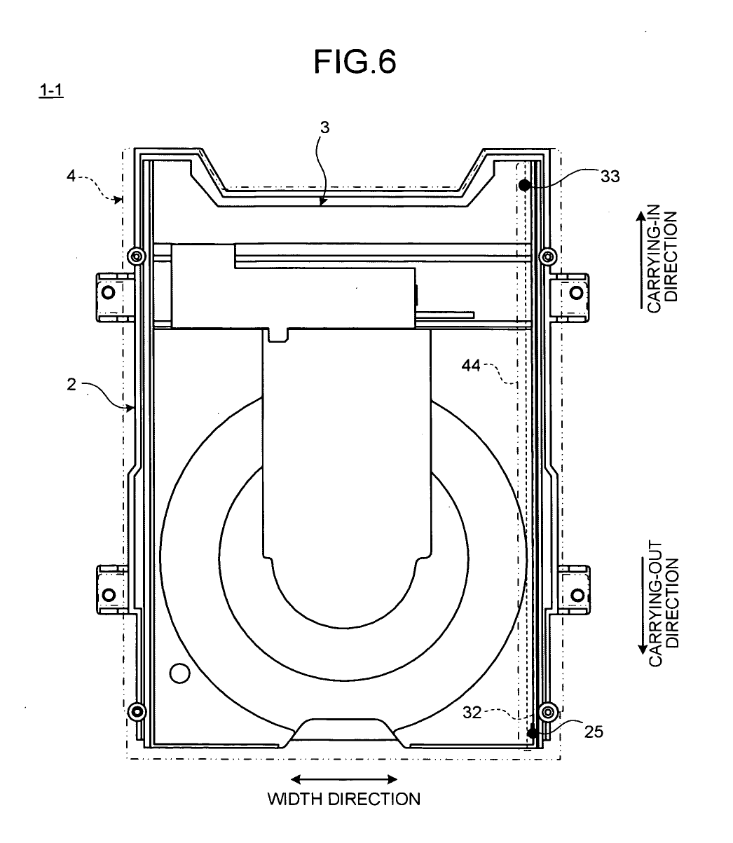

FIGS. 1-1 and 1-2 are cross sectional views of a main portion of a disk device according to a first practical example of the present invention. FIGS. 2-1 and 2-2 are diagrams illustrating a configuration example of a chassis. FIGS. 3-1 and 3-2 are diagrams illustrating a configuration example of a tray. FIGS. 4-1 and 4-2 are diagrams illustrating a configuration example of an upper case. FIG. 5 is a diagram illustrating a configuration example of the disk device at a disk loading position. FIG. 6 is a diagram illustrating a configuration example of the disk device at a disk reproducing position. In the first practical example, there is explained a disk device that includes a tray capable of carrying in any of a disk housed in a cartridge and a disk not housed in a cartridge. The disk device according to the first practical example can reproduce information recorded on either the disk housed in the carried cartridge or the disk not housed in the cartridge, and also can record information on the disk. Incidentally, the present invention is not limited to the above embodiments. The present invention can be applied to any disk device as long as the disk device includes a tray capable of carrying a disk in the disk device, and can perform at least any one of a reproduction of information recorded on a disk housed in a carried cartridge and a recording of information on the disk. Incidentally, the disk can be an optical disk, such as a DVD (Digital Versatile Disk), a CD (Compact Disk), a BD (Blue-ray Disk), and a HDDVD (High Definition Digital Versatile Disk).

As shown in FIGS. 1-1 and 1-2, a disk device 1-1 includes a chassis 2, a tray 3, and an upper case 4. The tray 3 is housed between the chassis 2 and the upper case 4 so that the tray 3 can move between a disk loading position at which a disk (not shown) is loaded and a disk reproducing position at which the loaded disk is reproduced or recorded thereon.

As shown in FIGS. 2-1 and 2-2, a mounting space 21 is formed on the inner side of the chassis 2, and various components included in the disk device 1-1 are mounted in the mounting space 21. Incidentally, when the tray 3 is located at the disk reproducing position, the tray 3 is also housed in the mounting space 21 in addition to the above components. As the various components mounted on the chassis 2, for example, there are a tray moving unit for moving the tray 3 between the disk loading position and the disk reproducing position, a drive motor (not shown), and a traversing mechanism (not shown) that moves up and down in conjunction with the movement of the tray 3.

The traversing mechanism includes, for example, a disk clamping unit that clamps a disk (not shown) housed in a cartridge or a disk (not shown) not housed in a cartridge, a disk rotating unit that rotates the disk clamped by the disk clamping unit, and a reproducing/recording unit that reads information recorded on the disk and writes information on the disk. The disk clamping unit can be a turntable, the disk rotating unit can be a disk rotating motor, and the reproducing/recording unit can be a pickup. Incidentally, a control of each of the tray moving unit (not shown), the disk rotating unit (not shown), the reproducing/recording unit (not shown), and the like is performed by a control unit (not shown).

Four positioning pins 22a to 22d for determining a position of the upper case 4 are formed on the chassis 2. In addition, fixation holes 23a to 23d for fixing the chassis 2 to an electronic device on which the disk device 1-1 is mounted together with the upper case 4 are formed on the chassis 2.

Moreover, a fixed-side projection 25 is formed on the chassis 2 in such a manner that the fixed-side projection 25 projects from a bottom surface 24 of the chassis 2 toward the mounting space 21. Namely, the fixed-side projection 25 is formed on a position to be opposed to the tray 3 in the disk device 1-1. A width of the fixed-side projection 25 in a width direction of the disk device 1-1 is slightly shorter than a width of a fixed-side groove 32, which is described later, of the tray 3 in the width direction of the disk device 1-1. The fixed-side projection 25 is formed near an edge portion of the bottom surface 24 of the chassis 2 in a direction from the disk reproducing position toward the disk loading position, i.e., in a carrying-out direction. The fixed-side projection 25 is formed on the side of one side surface out of both side surfaces of the chassis 2 (on the right side in FIGS. 2-1 and 2-2) on the bottom surface 24 of the chassis 2.

The tray 3 moves between the disk loading position (see FIG. 6) and the disk reproducing position (see FIG. 5). The tray 3 is movably supported by a plurality of guide members (not shown) formed on the chassis 2 so that the tray 3 can move between the disk loading position and the disk reproducing position. Incidentally, the tray moving unit (not shown) causes movement of the tray 3. Namely, the tray moving unit (not shown) moves the tray 3 from the disk loading position to the disk reproducing position when the tray 3 is to be carried in the disk device 1-1, and moves the tray 3 from the disk reproducing position to the disk loading position when the tray 3 is to be carried out of the disk device 1-1.

As shown in FIGS. 3-1 and 3-2, a loading portion 31 is formed in the substantially center of the tray 3. The loading portion 31 has an area enough for loading a cartridge (not shown) in which a disk is housed. Concave loading portions 31a and 31b for a disk not housed in a cartridge to be loaded thereon are formed on the loading portion 31. A disk having a large diameter (12 cm) can be loaded on the concave loading portion 31a. A disk having a small diameter (for example, 8 cm) can be loaded on the concave loading portion 31b. Incidentally, 31c denotes a positioning pin to be inserted into a positioning hole of a cartridge (not shown) when the cartridge (not shown) is loaded on the loading portion 31.

The fixed-side groove 32 is formed on one surface of the tray 3. In this practical example the fixed-side groove 32 is formed on a rear surface 3a opposed to the bottom surface 24 of the chassis 2. The fixed-side groove 32 is opened into the rear surface 3a. Moreover, the fixed-side groove 32 is formed on the tray 3 to be opposed to the fixed-side projection 25 formed on the chassis 2. The fixed-side groove 32 is formed to extend in a carrying direction (i.e., a carrying-in and carrying-out directions) of the tray 3 so that the fixed-side groove 32 is opposed to the fixed-side projection 25 even if the tray 3 is moved from the disk loading position to the disk reproducing position. Namely, the fixed-side groove 32 is formed at least in a moving area of the tray 3 with respect to the fixed-side projection 25.

A relative-moving-side projection 33 is formed on the other surface, i.e., a front surface 3b opposed to a ceiling surface 41, which is described later, of the upper case 4, of the tray 3. The relative-moving-side projection 33 is formed to project from the front surface 3b toward the upper case 4. Namely, the relative-moving-side projection 33 is formed on a position to be opposed to the disk device 1-1, in this case, the upper case 4. A diameter of the relative-moving-side projection 33 is slightly smaller than a width of a relative-moving-side groove 44, which is described later, of the upper case 4 in the width direction of the disk device 1-1. The relative-moving-side projection 33 is formed near an edge portion of the front surface 3b of the tray 3 in a direction from the disk loading position toward the disk reproducing position, i.e., in the carrying-in direction. The relative-moving-side projection 33 is formed on the side of one side surface out of both side surfaces of the tray 3 (on the right side in FIGS. 3-1 and 3-2) on the front surface 3b of the tray 3. Namely, the relative-moving-side projection 33 and the fixed-side groove 32 are respectively formed on an opposite surface of the tray 3, i.e., on the front surface 3b and the rear surface 3a. Incidentally, 34 denotes a sliding member that opens a shutter of a cartridge (not shown) to expose a disk housed in the cartridge to outside the cartridge. The sliding member 34 slides in a direction perpendicular to a moving direction of the tray 3, in this case, in the width-direction of the disk device 1 (in a horizontal direction in FIGS. 3-1 and 3-2) in conjunction with a movement of the tray 3.

As shown in FIGS. 4-1 and 4-2, the upper case 4 covers the chassis 2 so as to enclose the mounting space 21. Positioning holes 42a to 42d, which are respectively opposed to the four positioning pins 22a to 22d on the chassis 2, are formed on the ceiling surface 41 of the upper case 4 opposed to the tray 3. In addition, fixation holes 43a to 43d for fixing the upper case 4 to the electronic device on which the disk device 1-1 is mounted together with the chassis 2 are formed on the upper case 4.

Moreover, the relative-moving-side groove 44 opened into the ceiling surface 41 is formed on the upper case 4. The relative-moving-side groove 44 is formed on the upper case 4 to be opposed to the relative-moving-side projection 33 formed on the tray 3. The relative-moving-side groove 44 is formed to extend in the carrying direction (both the carrying-in direction and the carrying-out direction) of the tray 3 so that the relative-moving-side groove 44 is opposed to the relative-moving-side projection 33 even if the tray 3 is moved from the disk loading position to the disk reproducing position. Namely, the relative-moving-side groove 44 is formed at least in a moving area of the relative-moving-side projection 33 with respect to the disk device 1-1, in this case, the upper case 4.

Subsequently, how the disk device 1-1 is assembled is explained below. First, for example, the tray moving unit (not shown) and the traversing mechanism (not shown) are mounted on the chassis 2. Then, the tray 3 is movably supported by the plurality of the guide members (not shown) of the chassis 2 so that the tray 3 can move in the carrying direction. And then, in a state where the tray 3 is supported by the chassis 2, the positioning pins 22a to 22d on the chassis 2 are respectively inserted into the positioning holes 42a to 42d on the upper case 4, and thereby determining a position of the upper case 4 with respect to the chassis 2. At this time, an engaging projection (not shown) formed on the upper case 4 is inserted into an engaged groove (not shown) formed on the chassis 2, and the upper case 4 is engaged with the chassis 2. In this state, the assembly of the disk device 1-1 is completed. Incidentally, the assembled disk device 1-1 is fixed to the electronic device with a fixing member (not shown), such as a screw, via the fixation holes 23a to 23d on the chassis 2 and the fixation holes 43a to 43d on the upper case 4.

In the state where the disk device 1-1 has been assembled, as shown in FIGS. 1-1 and 1-2, the fixed-side projection 25 on the chassis 2 engages with the fixed-side groove 32 on the tray 3, and the relative-moving-side projection 33 on the tray 3 engages with the relative-moving-side groove 44 on the upper case 4. Namely, the relative-moving-side projection 33 and the relative-moving-side groove 44, and the fixed-side projection 25 and the fixed-side groove 32 respectively compose a sliding mechanism composed of the projection and the groove. Therefore, two sliding mechanisms are formed in the disk device 1-1.

Subsequently, states of the disk device 1-1 when the tray 3 is located at the disk loading position and the disk reproducing position are explained below. First, as shown in FIG. 5, when the tray 3 is located at the disk loading position, the most part of the tray 3 is located outside the disk device 1-1. At this time, a state where the fixed-side projection 25 and the relative-moving-side projection 33 respectively engage with the fixed-side groove 32 and the relative-moving-side groove 44 is maintained. The relative-moving-side projection 33 is formed near the edge portion of the tray 3 in the carrying-in direction, and the fixed-side projection 25 is formed near the edge portion of the chassis in the carrying-out direction. Namely, when the tray 3 is located at the disk loading position, the relative-moving-side projection 33 is located on the side of the disk reproducing position as compared with the fixed-side projection 25. Therefore, while the tray 3 is being moved, i.e., while the tray 3 is moved from the disk loading position to the disk reproducing position, the relative-moving-side projection 33 is not overlapped with the fixed-side projection 25 in a thickness direction of the disk device 1-1 (see FIG. 1-1). Therefore, the tray 3 can be restrained from being heavily tilted to the width direction of the disk device 1-1 that is caused when the relative-moving-side projection 33 is overlapped with the fixed-side projection 25 in the thickness direction of the disk device 1-1 while the tray 3 is being moved. Consequently, it is possible to suppress swaying of the tray 3 when the tray is moved.

Subsequently, while the tray 3 is moved from the disk loading position to the disk reproducing position, i.e., while the tray 3 is being moved, the fixed-side groove 32 moves in the carrying-in direction of the tray 3 with respect to the fixed-side projection 25 with keeping the state where the fixed-side projection 25 engages with the fixed-side groove 32. In addition, the relative-moving-side projection 33 moves in the carrying-in direction of the tray 3 with respect to the relative-moving-side groove 44 with keeping the state where the relative-moving-side projection 33 engages with the relative-moving-side groove 44. Namely, even while the tray 3 is being moved, the states where the fixed-side projection 25 and the relative-moving-side projection 33 respectively engage with the fixed-side groove 32 and the relative-moving-side groove 44 are maintained. At this time, the relative-moving-side projection 33 relatively moves with respect to the fixed-side projection 25 in accordance with the movement of the tray 3. When the tray 3 is moved in the carrying-in direction, the relative-moving-side projection 33 moves away from the fixed-side projection 25 in accordance with the movement of the tray 3 while the tray 3 is moved from the disk loading position to the disk reproducing position. On the other hand, when the tray 3 is moved in the carrying-out direction, the relative-moving-side projection 33 moves close to the fixed-side projection 25 in accordance with the movement of the tray 3 while the tray 3 is moved from the disk reproducing position to the disk loading position.

When the tray 3 located at the disk loading position is moved to the disk reproducing position, the tray 3 is housed in the disk device 1-1. At this time, the states where the fixed-side projection 25 and the relative-moving-side projection 33 respectively engage with the fixed-side groove 32 and the relative-moving-side groove 44 are still maintained. Therefore, while the tray 3 is being moved, the tray 3 is constantly restrained from being moved in the width direction of the disk device 1-1 at two points. As a result, while the tray 3 is being moved, the projection never engages with the groove. Furthermore, the tray 3 is restrained from being tilted while the tray 3 is being moved, which prevents the relative-moving-side projection 33 and the fixed-side groove 32 of the tray 3 from colliding with the components arranged in the disk device 1-1. Consequently, it is possible to suppress swaying of the tray 3 when the tray 3 is moved.

Moreover, in the disk device 1-1, the movement of the tray 3 in the width direction of the disk device 1-1 can be restrained by the two sliding mechanisms composed of the relative-moving-side projection 33 and the relative-moving-side groove 44, and the fixed-side projection 25 and the fixed-side groove 32, respectively. Therefore, it is not necessary to include a plurality of projections to be engaged with a groove as those employed in a conventional disk device, so that the disk device 1-1 can be downsized.

Furthermore, in the disk device 1-1 according to the first practical example, the relative-moving-side projection 33 and the fixed-side groove 32 of the tray 3 are formed on the same side of the side surface out of the both side surfaces of the disk device 1-1, however, the present invention is not limited to such a configuration. For example, the relative-moving-side projection 33 can be formed on the side of one side surface out of the both side surfaces of the tray 3, and the fixed-side groove 32 can be formed on the side of the other side surface. Namely, the relative-moving-side projection 33 and the fixed-side groove 32 can be formed on the side of each of the both side surfaces of the disk device 1-1, respectively.

Moreover, in the disk device 1-1 according to the first practical example, the relative-moving-side projection 33 and the fixed-side groove 32 are formed on the same side of the side surface out of the both side surfaces of the disk device 1-1. It is more preferable that the fixed-side groove 32 is formed on a position to be overlapped with the moving area of the relative-moving-side projection 33 with respect to the disk device 1-1 in the thickness direction of the disk device 1-1 (see FIGS. 1-1, 5, and 6). With such a configuration, the fixed-side projection 25 is constantly located on the moving area of the relative-moving-side projection 33 with respect to the disk device 1-1 while the tray 3 is moved from the disk loading position to the disk reproducing position. Therefore, the tray 3 can be restrained from being tilted to the width direction of the disk device 1-1 while the tray 3 is moved from the disk loading position to the disk reproducing position as compared with a case where the relative-moving-side projection 33 and the fixed-side projection 25 are not arranged on the same straight line. Consequently, it is possible to more reliably suppress swaying of the tray 3 when the tray 3 is moved.

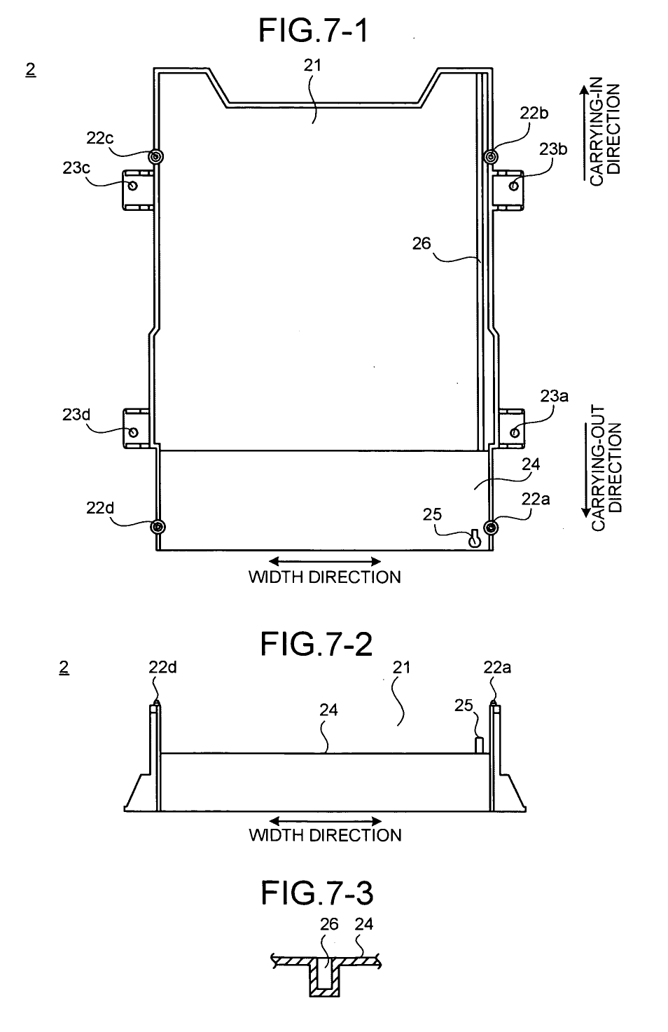

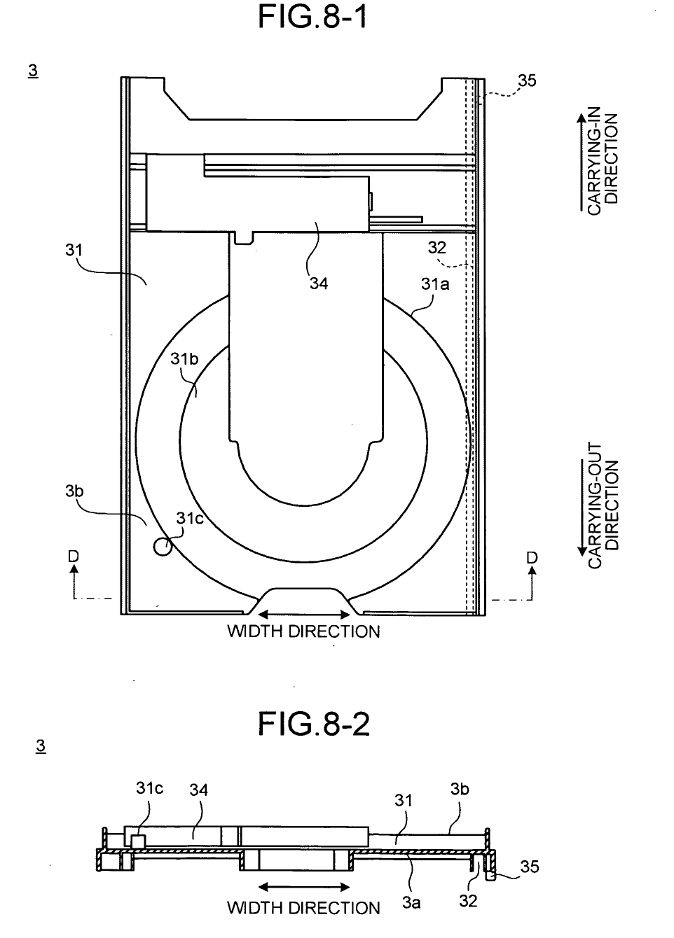

Furthermore, in the disk device 1-1 according to the first practical example, the relative-moving-side projection 33 and the fixed-side groove 32 are respectively formed on an opposite surface of the tray 3, i.e., on the front surface 3b and the rear surface 3a, but the present invention is not limited to the configuration. FIGS. 7-1 to 7-3 are diagrams illustrating another configuration example of the chassis. FIGS. 8-1 and 8-2 are diagrams illustrating another configuration example of the tray.

As shown in FIGS. 8-1 and 8-2, the fixed-side groove 32 and a relative-moving-side projection 35 can be formed on one surface of the tray 3, in this case, the rear surface 3a. When such a configuration is employed, as shown in FIGS. 7-1 to 7-3, a relative-moving-side groove 26 that can engage with the relative-moving-side projection 35 is formed on the chassis 2.

As described above, the disk device 1-1 according to the first practical example, which performs a reproduction of information recorded on a disk and a recording of information on the disk, includes the relative-moving-side projection 33 formed on the tray 3 being moved between the disk loading position at which the disk is loaded and the disk reproducing position at which information in the loaded disk is reproduced or information is recorded on the loaded disk, the relative-moving-side groove 44 formed in the moving area of the relative-moving-side projection 33 with respect to the disk device 1-1 in the state where the relative-moving-side projection 33 engages with the relative-moving-side groove 44 on the upper case 4 in the disk device 1-1, the fixed-side projection 25 formed on a position on the chassis 2 in the disk device 1-1 to be opposed to the tray 3, and the fixed-side groove 32 formed in the moving area of the tray 3 with respect to the fixed-side projection 25 in the state where the fixed-side projection 25 engages with the fixed-side groove 32 on the tray 3. Therefore, it is possible to suppress swaying of the tray 3 when the tray 3 is moved, and downsize.

### Second practical example

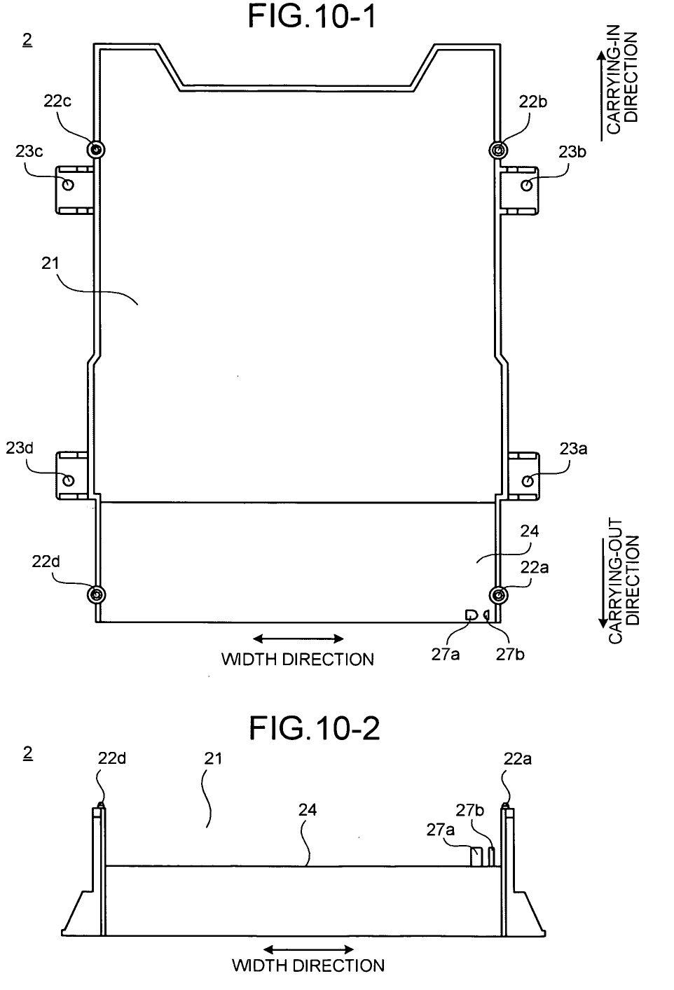

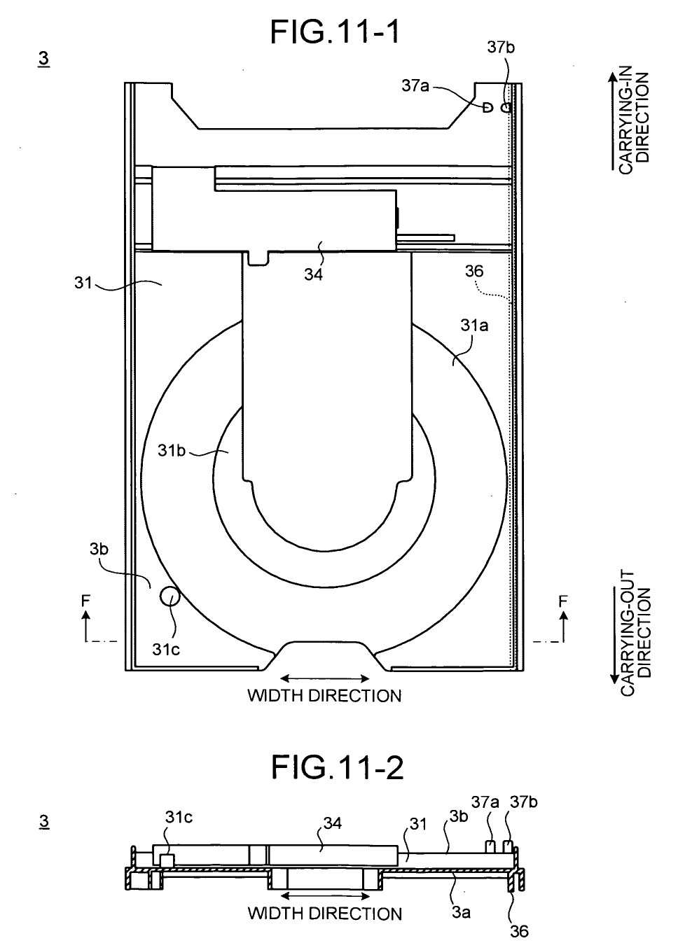

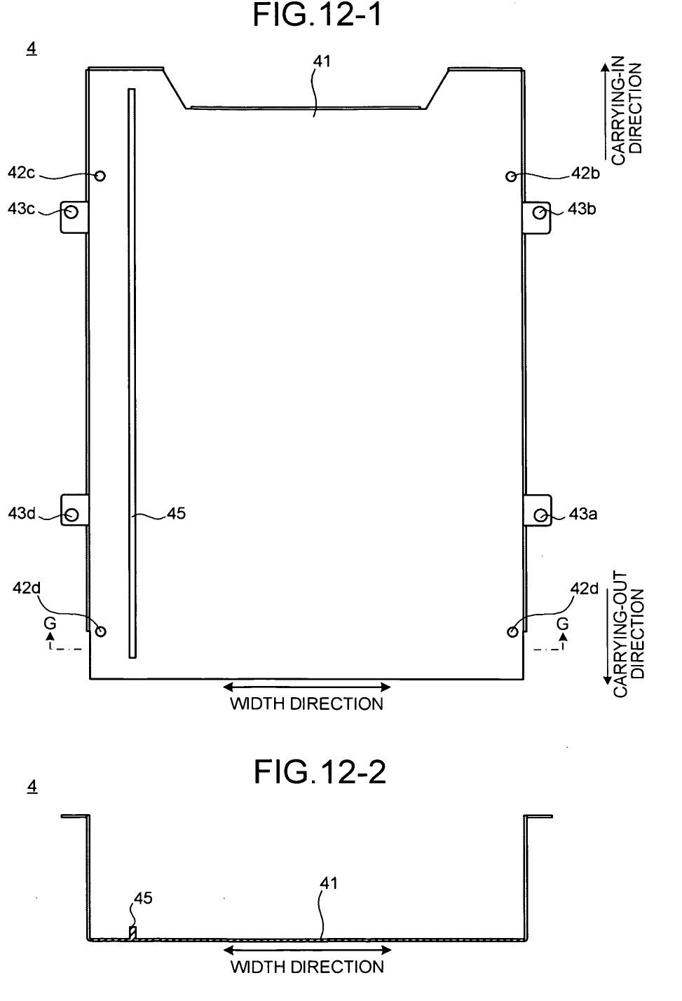

A disk device 1-2 according to a second practical example of the present invention is explained below. FIGS. 9-1 and 9-2 are cross sectional views of a main portion of the disk device according to the second practical example. FIGS. 10-1 and 10-2 are diagrams illustrating a configuration example of a chassis. FIGS. 11-1 and 11-2 are diagrams illustrating a configuration example of a tray. FIGS. 12-1 and 12-2 are diagrams illustrating a configuration example of an upper case. The difference between the disk device 1-2 according to the second practical example shown in FIGS. 9-1 to 12-2 and the disk device 1-1 according to the first practical example shown in FIGS. 1-1 to 6 is that the disk device 1-2 includes a fixed sliding mechanism in which a rib is sandwiched between a pair of guide projections instead of the sliding mechanism in which the projection engages with the groove. Out of basic elements of the disk device 1-2 according to the second practical example, the portions identical to basic elements of the disk device 1-1 according to the first practical example (which are denoted with the same reference numerals in FIGS. 9-1 to 12-2 as those shown in FIGS. 1-1 to 6) are explained in a simplified manner, or the explanation of those portions is omitted.

As shown in FIGS. 10-1 and 10-2, a pair of fixed-side guide projections 27a and 27b are formed on the chassis 2 to project from the bottom surface 24 toward the mounting space 21. Namely, the pair of the fixed-side guide projections 27a and 27b are formed on a position to be opposed to the tray 3 in the disk device 1-2. A distance between the pair of the fixed-side guide projections 27a and 27b in a width direction of the disk device 1-2 is slightly longer than a width of a fixed-side rib 36, which is described later, of the tray 3 in the width direction of the disk device 1-2. The pair of the fixed-side guide projections 27a and 27b are formed near an edge portion of the bottom surface 24 of the chassis 2 in a direction from the disk reproducing position toward the disk loading position, i.e., in the carrying-out direction. The pair of the fixed-side guide projections 27a and 27b are formed on the side of one side surface out of both side surfaces of the chassis 2 (on the right side in FIGS. 10-1 and 10-2) on the bottom surface 24 of the chassis 2.

As shown in FIGS. 11-1 and 11-2, the fixed-side rib 36 is formed on one surface of the tray 3, in this case, the rear surface 3a to project toward the tray 3. The fixed-side rib 36 is formed on the tray 3 to be opposed to the pair of the fixed-side guide projections 27a and 27b formed on the chassis 2. The fixed-side rib 36 is formed to extend in the carrying direction (both the carrying-in direction and the carrying-out direction) of the tray 3 so that the fixed-side rib 36 is opposed to the fixed-side guide projections 27a and 27b even if the tray 3 is moved from the disk loading position to the disk reproducing position. Namely, the fixed-side rib 36 is formed at least in a moving area of the tray 3 with respect to the pair of the fixed-side guide projections 27a and 27b.

A pair of relative-moving-side guide projections 37a and 37b are formed on the other surface of the tray 3, in this case, the front surface 3b to project from the front surface 3b toward the upper case 4. Namely, the pair of the relative-moving-side guide projections 37a and 37b are formed on a position to be opposed to the upper case 4 in the disk device 1-2. A distance between the pair of the relative-moving-side guide projections 37a and 37b in the width direction of the disk device 1-2 is slightly longer than a width of a relative-moving-side rib 45, which is described later, of the upper case 4 in the width direction of the disk device 1-2. The pair of the relative-moving-side guide projections 37a and 37b are formed near an edge portion of the front surface 3b of the tray 3 in a direction from the disk loading position toward the disk reproducing position, i.e., in the carrying-in direction. The pair of the relative-moving-side guide projections 37a and 37b are formed on the side of one side surface out of both side surfaces of the tray 3 (on the right side in FIGS. 11-1 and 11-2) on the front surface 3b of the tray 3. Namely, the pair of the relative-moving-side guide projections 37a and 37b and the fixed-side rib 36 are respectively formed on an opposite surface of the tray 3, i.e., on the front surface 3b and the rear surface 3a.

As shown in FIGS. 12-1 and 12-2, the relative-moving-side rib 45 is formed on the ceiling surface 41 of the upper case 4 to project toward the tray 3. The relative-moving-side rib 45 is formed on the upper case 4 to be opposed to the pair of the relative-moving-side guide projections 37a and 37b formed on the tray 3. The relative-moving-side rib 45 is formed to extend in the carrying direction (both the carrying-in direction and the carrying-out direction) of the tray 3 so that the relative-moving-side rib 45 is opposed to the pair of the relative-moving-side guide projections 37a and 37b even if the tray 3 is moved from the disk loading position to the disk reproducing position. Namely, the relative-moving-side rib 45 is formed at least in a moving area of the pair of the relative-moving-side guide projections 37a and 37b with respect to the upper case 4 in the disk device 1-2.

In a state where the disk device 1-2 has been assembled, as shown in FIGS. 9-1 and 9-2, the fixed-side rib 36 on the tray 3 is sandwiched between the pair of the fixed-side guide projections 27a and 27b on the chassis 2, and the relative-moving-side rib 45 on the upper case 4 is sandwiched between the pair of the relative-moving-side guide projections 37a and 37b on the tray 3. Namely, the pair of the relative-moving-side guide projections 37a and 37b and the relative-moving-side rib 45, and the pair of the fixed-side guide projections 27a and 27b and the fixed-side rib 36 respectively compose a sliding mechanism composed of the pair of the guide projections and the rib sandwiched between the pair of the guide projections. Therefore, two sliding mechanisms are formed in the disk device 1-2.

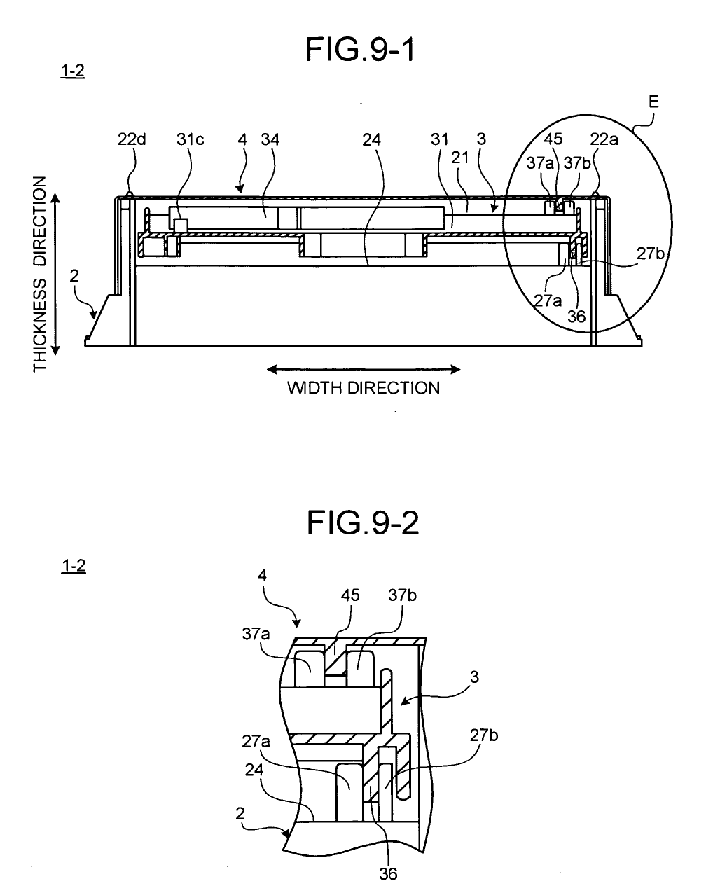

In the disk device 1-2, when the tray 3 is located at the disk loading position, a state where the fixed-side rib 36 and the relative-moving-side rib 45 are respectively engaged with the pair of the fixed-side guide projections 27a and 27b and the pair of the relative-moving-side guide projections 37a and 37b is maintained. At this time, the pair of the relative-moving-side guide projections 37a and 37b are formed near the edge portion of the tray 3 in the carrying-in direction, and the pair of the fixed-side guide projections 27a and 27b are formed near the edge portion of the chassis 2 in the carrying-out direction. Namely, when the tray 3 is located at the disk loading position, the pair of the relative-moving-side guide projections 37a and 37b are located on the side of the disk reproducing position as compared with the fixed-side guide projections 27a and 27b. Therefore, while the tray 3 is being moved, i.e., when the tray 3 is moved from the disk loading position to the disk reproducing position, the pair of the relative-moving-side guide projections 37a and 37b are not overlapped with the fixed-side guide projections 27a and 27b in a thickness direction of the disk device 1-2 (see FIG. 9-1). Therefore, the tray 3 can be restrained from being tilted to the width direction of the disk device 1-2 that is caused when the pair of the relative-moving-side guide projections 37a and 37b are overlapped with the pair of the fixed-side guide projections 27a and 27b in the thickness direction of the disk device 1-2 while the tray 3 is being moved. Consequently, it is possible to suppress swaying of the tray 3 when the tray 3 is moved.

Furthermore, when the tray 3 is moved from the disk loading position to the disk reproducing position, i.e., even while the tray 3 is being moved, the state where the fixed-side rib 36 and the relative-moving-side rib 45 are respectively engaged with the pair of the fixed-side guide projections 27a and 27b and the pair of the relative-moving-side guide projections 37a and 37b is maintained. At this time, the pair of the relative-moving-side guide projections 37a and 37b relatively move with respect to the fixed-side guide projections 27a and 27b in accordance with the movement of the tray 3. When the tray 3 is moved in the carrying-in direction, the pair of the relative-moving-side guide projections 37a and 37b move away from the fixed-side guide projections 27a and 27b in accordance with the movement of the tray 3. On the other hand, when the tray 3 is moved in the carrying-out direction, the pair of the relative-moving-side guide projections 37a and 37b move close to the pair of the fixed-side guide projections 27a and 27b in accordance with the movement of the tray 3.

Moreover, when the tray 3 is moved from the disk loading position to the disk reproducing position, the state where the fixed-side rib 36 and the relative-moving-side rib 45 are respectively engaged with the pair of the fixed-side guide projections 27a and 27b and the pair of the relative-moving-side guide projections 37a and 37b is maintained. Therefore, while the tray 3 is being moved, the tray 3 is constantly restrained from being moved in the width direction of the disk device 1-2 at two points. As a result, while the tray 3 is being moved, the rib that is not sandwiched between the guide projections is never sandwiched between the guide projections. Furthermore, the tray 3 is restrained from being tilted while the tray 3 is being moved, and thereby preventing the relative-moving-side rib 45 and the fixed-side rib 36 from colliding with components arranged in the disk device 1-2. Consequently, it is possible to suppress swaying of the tray 3 when the tray 3 is moved.

Furthermore, in the disk device 1-2, the movement of the tray 3 in the width direction of the disk device 1-2 can be restrained by the two sliding mechanisms composed of the pair of the relative-moving-side guide projections 37a and 37b and the relative-moving-side rib 45, and the pair of the fixed-side guide projections 27a and 27b and the fixed-side rib 36, respectively. Therefore, it is not necessary to include a plurality of pairs of the guide projections for sandwiching the rib therebetween as those employed in a conventional disk device, so that the disk device 1-2 can be downsized.

As described above, the disk device 1-2 according to the second practical example, which performs a reproduction of information recorded on a disk and a recording of information on the disk, includes the pair of the relative-moving-side guide projections 37a and 37b formed on the tray 3 being moved between the disk loading position at which the disk is loaded and the disk reproducing position at which information in the loaded disk is reproduced or information is recorded on the loaded disk, the relative-moving-side rib 45 formed in the moving area of the pair of the relative-moving-side guide projections 37a and 37b with respect to the upper case 4 in the disk device 1-2 in a state where the relative-moving-side rib 45 is sandwiched between the pair of the relative-moving-side guide projections 37a and 37b in the disk device 1-2, the pair of the fixed-side guide projections 27a and 27b formed on a position to be opposed to the tray 3 in the disk device 1-2, and the fixed-side rib 36 formed in the moving area of the tray 3 with respect to the pair of the fixed-side guide projections 27a and 27b in a state where the fixed-side rib 36 is sandwiched between the pair of the fixed-side guide projections 27a and 27b. Therefore, it is possible to suppress swaying of the tray 3 when the tray 3 is moved, and downsize.

### INDUSTRIAL APPLICABILITY

As described above, the disk device according to the present invention is useful for a disk device capable of using any of a disk housed in a cartridge and a disk not housed in a cartridge. Particularly, the disk device according to the present invention is suitable for the purpose of a restraint of a tray being moved from swaying and a downsizing of.

1-4. (canceled)

5. A disk device that performs at least any one of reproduction of information recorded on a disk and recording of information on the disk, the disk device comprising:
a relative-moving-side projection formed on a tray being moved between a disk loading position at which the disk is loaded and a disk reproducing position at which information in a loaded disk is reproduced or information is recorded on the loaded disk;
a relative-moving-side groove formed at least in a moving area of the relative-moving-side projection with respect to the disk device such a manner that the relative-moving-side projection engages with the relative-moving-side groove in the disk device;
a fixed-side projection formed on a position in the disk device to be opposed to the tray; and
a fixed-side groove formed at least in a moving area of the tray with respect to the fixed-side projection such a manner that the fixed-side projection engages with the fixed-side groove on the tray, wherein
the relative-moving-side projection and the fixed-side groove are formed on opposite surfaces of the tray, and
the fixed-side groove is formed on a position to be overlapped with the moving area of the relative-moving-side projection with respect to the disk device in a thickness direction of the disk device.

6. The disk device according to claim 5, wherein when the tray is located at the disk loading position, the relative-moving-side projection is located on a side of the disk reproducing position as compared with the fixed-side projection.
